(19) United States
(12) Patent Application Publication
(10) Pub. No.: US 2010/0110002 A1
(43) Pub. Date: May 6, 2010

(54) COMMUNICATION DEVICE WITH COMBINED INPUT AND DISPLAY DEVICE

(75) Inventors: David BURSTROM, Lund (SE); Henrik Bengtsson, Lund (SE); Anders Ostsjo, Bjarred (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/265,994

(22) Filed: Nov. 6, 2008

(51) Int. Cl. H04B 1/10

(52) U.S. Cl. 345/157

(57) ABSTRACT

The present invention relates to a communication device comprising a combined input and display device for character input and image display and a method for controlling said character input and image display. The device comprises a control unit and a proximity sensor arranged in such a way that the sensor is able to detect when a pointer comes within a first predetermined distance from the input and display device and that the control unit is configured to generate a first control signal for changing display modes, from a first to a second display mode, upon detection of the pointer. The second display mode is kept until the pointer is withdrawn more then a second predetermined distance from the display device at which occasion the control unit is configured to generate a second control signal for changing display modes, from the second to the first display mode.

### TECHNICAL FIELD OF THE INVENTION

The present invention relates to the field of communication devices and more particularly to a communication device comprising a combined input and display unit for character input and image display. Furthermore, the present invention also relates to a method for controlling character input and display in a communication device. Preferably, the invention is used in conjunction with communication devices that have a limited area for display purposes

### DESCRIPTION OF RELATED ART

Communication devices such as e.g. cellular telephones may provide a MMI (Man-Machine-Interface) such as a physical keyboard or keypad and a display of some sort, e.g. a conventional TFT display, a combined TFT virtual keyboard/display, or any other type of input and display combination.

The most widely used alphabetic keyboard layout is the QWERTY layout, but there are many others, e.g. AZERTY or DVORAC layouts. Alphabetic keyboard layouts are as mentioned above often presented in combination with a numeric keypad layout.

In a common layout, the numbers 1 to 9 and zero are positioned above the alphabetic keys. Portable communication devices that include a combined alphabetic keyboard and a numeric keypad are also known.

Some communication devices incorporate a reduced alphabetic keyboard in which the number of numeric keys is reduced by allocating multiple alphabetic characters to certain keys. In one such device a first keystroke displays a list of eligible characters and subsequent keystrokes scroll through the list and selects. Hereby each key can be larger, but the number of keystrokes typically needed to input e.g. text, is multiplied compared to what is needed to operate devices having traditional layouts.

Other communication devices may include a disambiguation engine that analyzes the keystroke sequence and suggests character strings or words. The disambiguation engine calculates probabilities on the basis of some assigned glossary, and as long as the intended word is listed in the assigned glossary operation is effective. Input of foreign words, trade terms, proper nouns, names or slang, however, will likely require multiple keystrokes, in order to browse eligible suggested combinations of characters, or even require disabling of the disambiguation engine.

Combining a traditional alphabetic keyboard such as a QWERTY keyboard, with a traditional numeric keypad on the same communication device typically involves undesirable ergonomic and non-intuitive MMI compromises. Most people are used to and prefer the QWERTY layout, but in order for such a layout to fit a small device such as a cellular telephone, the individual keys have to be miniaturized to a degree where they are impossible to operate with a finger, or even difficult for the eye to distinguish. A stylus is sometimes included as a part of the input unit. The stylus may facilitate operation, but does nothing to increase distinguishability. Furthermore, styluses have an annoying tendency to go missing when they are needed.

Thus, there is a need for a communication device and a method where the input characters are easy to distinguish and at the same time minimize the necessary keystrokes needed to input the information in the device.

### SUMMARY OF THE INVENTION

One object of the invention is to solve the problems with poor precision, usability and ergonomics that occur in relation to input of information, in order to improve distinguishability, reduce the amount of keystrokes needed and speed up character selection.

According to a first aspect of the invention, this object is achieved by a communication device comprising a combined input and display device for character input and image display, a control unit and a proximity sensor, wherein the proximity sensor and the control unit are arranged in such a way that the sensor is able to detect when a pointer comes within a first predetermined distance from the input and display device and that the control unit is configured to generate a first control signal for changing display modes, from a first to a second display mode, upon detection of the pointer.

According to a further aspect the communication device also comprises storage means for storing the display-coordinates that are closest to the pointer upon detection thereof.

According to another aspect the control unit and proximity sensor also are arranged in such a way that the sensor is able to detect when a pointer is withdrawn more then a second predetermined distance from the display device and the control unit is configured to generate a second control signal for changing display modes, from the second to the first display mode, upon detection of the withdrawal of the pointer.

Preferably, the second predetermined distance is greater than the first predetermined distance.

According to yet another aspect of the invention the proximity sensor and the control unit are arranged in such a way that the sensor is able to detect when a pointer comes within a third predetermined distance from the input and display device and the control unit is configured to, upon detection of the pointer, generate a third control signal for inputting a value to the communication device.

Preferably, the third predetermined distance is smaller than the first predetermined distance.

In yet another embodiment of the present invention the combined input and display is touch sensitive and the third control signal is generated when the pointer is touching the display.

Preferably, the first display mode is a layout with multi-choice-keys and the second display mode is a layout with single-choice-keys and each set of single-choice-keys is associated with one specific multi-choice key. Furthermore, the individual single- or multi-mode keys in each mode are associated with an individual set of display coordinates.

According to a second aspect of the present invention there is provided a method for controlling character input and image display in a communication device comprising a combined input and display device, a control unit and a proximity sensor, said method comprising the following steps;
detecting when a pointer is within a first predetermined distance from the display;
generating a first control signal upon detection that the pointer is within the first predetermined distance,
changing display modes, from a first to a second display mode as a response to the first control signal.

Furthermore, the method comprises the step of storing the display-coordinates that are closest to the pointer upon detection thereof.

In another embodiment the method further comprises the steps of;
detecting when a pointer is withdrawn more then a second predetermined distance from the display device,
generating a second control signal upon the detection of withdrawal of the pointer,
changing display modes from the second to the first display mode as a response to the second control signal.

The second predetermined distance is greater than the first predetermined distance.

In yet another embodiment the method comprises the steps of;
detecting when a pointer is within a third predetermined distance from the display device,
generating a third control signal upon the detection of pointer within the third predetermined distance,
inputting a value to the communication device in response to the third control signal.

The third predetermined distance is smaller than the first predetermined distance.

The combined input and display is touch sensitive and the third control signal is generated when the pointer is touching the display.

In a preferred embodiment of the invention the first display mode shows a layout with multi-choice-keys and the second display mode shows a layout with single-choice-keys. Each set of single-choice-keys is associated with one specific multi-choice key and the individual single- or multi-mode keys in each mode are associated with an individual set of display coordinates.

According to a third aspect the invention also provides a computer program comprising code means for performing the steps of any one of the methods, when the program is run on the control unit.

According to a fourth aspect the present invention further comprises a computer program product comprising program code means stored on a computer readable medium for performing the method, when said product is run on the control unit.

Thus, with the present invention it is possible to improve the input accuracy by increasing the distinguishability of the input keys. Also the input efficiency and ergonomics are enhanced by the present invention.

### BRIEF DESCRIPTION OF THE DRAWINGS

The present invention will now be described in more detail in relation to the enclosed drawings, in which:

FIG. 1 schematically shows a front view of a portable communication device in the form a cellular telephone, having a proximity sensor, according to an embodiment of the invention,

FIG. 2 schematically shows a first display mode having a multi-choice key layout,

FIG. 3 schematically shows a second display mode having a single choice key layout.

### DETAILED DESCRIPTION OF EMBODIMENTS

For the sake of clarity, the word “pointer” should henceforth be taken to mean a stylus, a finger, a key or any other feasible object.

A communication device according to the present invention will now be described in relation to a cellular telephone, which is a preferred variation of the invention. However, the communication device can also be a phone, a communication module, a PDA or a laptop or any other device provided with a screen. However, the present invention is best used in combination with devices having limited space available for input and display units.

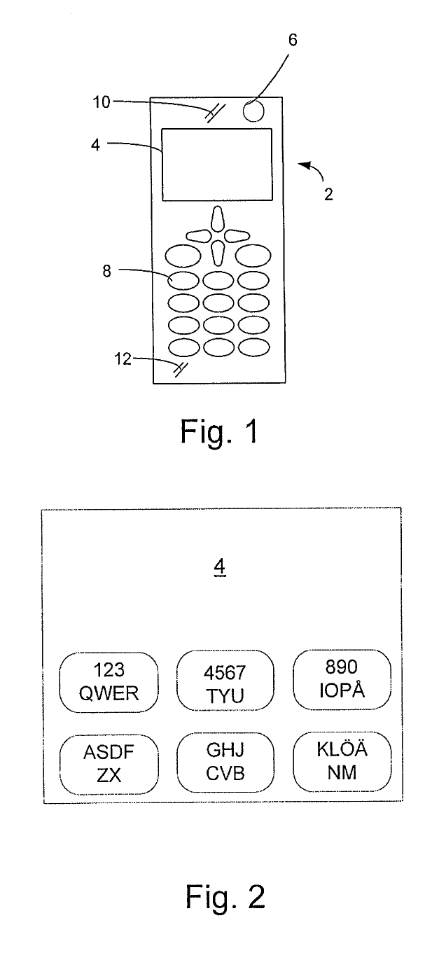

FIG. 1 schematically shows a front view of a cellular telephone 2 according to an embodiment of the present invention. The telephone 2 includes a combined input and display device 4, a proximity sensor 6, a number of keys 8 on a keypad provided below the combined input and display device 4, a loud speaker 10 and a microphone 12. These are all common features for a portable communication device and are well known by a person skilled in the art and are therefore not described in detail.

The input and display device 4 preferably comprises a touch screen, which enables a user to use the display as an input device. However, the type of screen used is not critical to the invention and the screen may be any screen on the market. With the present invention it is also possible to omit the keys or keypad 8 and instead use only the combined input and display device 4 as the inputting unit of the communication device 2.

The proximity sensor 6 depicted in FIG. 1 is capable of 3D proximity sensing. Thus, it may track a pointer that is appearing in front of the display 4, by collecting ambient data. In a preferred embodiment of the invention the proximity sensor may track any object objects that hovers over the display 4 at a distance from 0-10 centimeters.

The proximity sensor may be any suitable sensor available on the market, the important thing being that it is capable of 3D sensing and thereby also is capable of measuring the distance from the pointer to any given point on the display. Thus, the proximity senor may be realised as an optronic sensor, a heat sensor etc. It should also be understood that when using the term sensor in the present application, it does not mean that it has to be a single sensor, but that a “sensor” may comprise several sensor in order to sense the proximity.

Even if it is not shown in FIG. 1, it should be understood that the cellular telephone 2 also includes a control unit and storage means, which is well known by a person skilled in the art. The control unit may for example be connected to the proximity sensor 6 for receiving and acting on the data collected therewith.

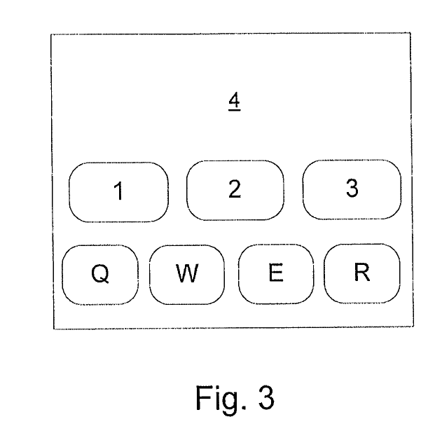

FIG. 2 shows the combined input and display device 2 when it is in a first display mode and FIG. 3 shows the device in a second display mode, which modes are to be described in detail below.

In this first display mode the layout comprises a keypad of 2 by 3 keys. Each key depicts a multi-choice key where several characters are associated with one key. For example the characters 1, 2, 3, 4, Q, W, E and R are associated with the upper left key, the characters 4, 5, 6, 7, T, Y and U are associated with the upper middle key and so forth. It should be understood that it is not important which characters or symbols are on which keys, but that the keys displayed in the first display mode are multi-choice keys.

In the second display mode the layout comprises a number of single-choice keys corresponding to the number of alphanumeric characters depicted on and associated multi-choice key in the first display mode. FIG. 3 shows seven single-choice keys associated with the upper left key in the first display mode.

Thus, now when the physical elements of the present invention have been described, it is time to describe the method for controlling the character input and display in the communication device.

The method starts when the communication is in a normal mode, i.e. the combined input and display device 4 is in its first display mode showing multi-choice keys. Now, when a user moves a pointer closer than a first predetermined distance from the upper left key, the proximity sensor 6 will detect this and the control unit will generate a first control signal. This first control signal will change the display mode from the first to the second display mode. As mentioned above, the second display mode shows single-choice keys instead for multi-choice keys. This will make it much easier for a user to “push” the right bottom and the number of keystrokes necessary for inputting a character is substantially reduced compared to prior art. The single-choice keys displayed in the second display mode are associated with the multi-choice key that triggered the change of display modes from the first to the second display mode. Both the first and second display mode layout is preferably equal in size, and either of them fills the entire screen.

The first predetermined distance is preferably two centimetres, but may of course be set do any suitable value. Thus, as explained above the proximity sensor 6 will make the control unit aware of that a pointer is within lets say two centimetres from the input and display device 4. The control unit will then initiate that the display-coordinates that are closest to the pointer and that triggered the change of display modes are stored in storage means. The control unit then uses these coordinates to decide which one of the multi-choice keys that were closest to the pointer. If it is decided that the upper left multi-choice key is the closest the single-choice keys associated therewith will be displayed in the second display mode.

In a preferred embodiment of the present invention the second display mode will be kept as long as the pointer is not withdrawn from the input and display device 4 more than a second predetermined distance from the display device. The second predetermined distance is preferably greater than the first predetermined distance. In a preferred embodiment the second predetermined distance is for example 3 centimetres. When the pointer is withdrawn beyond this second predetermined distance the proximity sensor 6 will detect this and the control unit will generate a second control signal. This second control signal will change the display mode from the second to the first display mode.

The benefit of having the second predetermined distance greater than the first is that flutter is avoided, which for instance is the case if both the first and second predetermined distance is the same and the pointer is kept constantly on that distance. Thus, according to the present invention it will be possible for a user to move a pointer back and forth over the screen, and also within various distances from the screen, without triggering a change of display modes.

It should be understood that the second predetermined distance not necessarily must be 3 centimetres, but could be any distance that is greater than the first predetermined distance.

In a preferred embodiment of the present invention, also an ordinary display screen, and not a touch screen, may be used as an input device. In this case the proximity sensor 6 will detect if the pointer is within a third predetermined distance from the single-choice keys in the second display mode. If the pointer reaches this close the control unit will generate a third control signal, which will initiate the inputting of the value that corresponds to the single-choice key that triggered the detection of the pointer.

Preferably, this third predetermined distance is 1 millimetre. Thus, with the present invention it is possible to use an ordinary screen and still make the user feel that it is a touch screen.

It should be understood that the third predetermined does not have to be 1 millimetre, but could be any distance that is smaller that the first predetermined distance.

In another embodiment the communication device comprises a touch screen. In this case the third control signal will be generated when a user touches the display instead of at the third predetermined distance.

The portable communication device according to the present invention can be varied in a number of ways apart from what has been disclosed above. For example, instead of a second display mode having the single-choice keys it would be possible to have a second display mode with multi-choice keys together with a third display mode having the single-choice keys. It shall also be understood that even if the present invention has been described with preferred embodiments having certain features it is obvious to a person skilled in the art that individual features in one embodiment could be combined with other embodiments or other individual features in other embodiments.

1. Communication device comprising a combined input and display device for character input and image display, a control unit and a proximity sensor, wherein the proximity sensor and the control unit are arranged in such a way that the sensor is able to detect when a pointer comes within a first predetermined distance from the input and display device and that the control unit is configured to generate a first control signal for changing display modes, from a first to a second display mode, upon detection of the pointer.

2. Communication device according to claim 1, further comprising storage means for storing the display-coordinates that are closest to the pointer upon detection thereof.

3. Communication device according to claim 1, wherein said control unit and proximity sensor are arranged in such a way that the sensor is able to detect when a pointer is withdrawn more then a second predetermined distance from the display device and that the control unit is configured to generate a second control signal for changing display modes, from the second to the first display mode, upon detection of the withdrawal of the pointer.

4. Communication device according to claim 3, wherein the second predetermined distance is greater than the first predetermined distance.

5. Communication device according to claim 1, wherein the proximity sensor and the control unit are arranged in such a way that the sensor is able to detect when a pointer comes within a third predetermined distance from the input and display device and that the control unit is configured to, upon detection of the pointer, generate a third control signal for inputting a value to the communication device.

6. Communication device according to claim 5 wherein the third predetermined distance is smaller than the first predetermined distance.

7. Communication device according to claim 5, wherein the combined input and display is touch sensitive and wherein the third control signal is generated when the pointer is touching the display.

8. Communication device according to claim 1, wherein the first display mode is a layout with multi-choice-keys.

9. Communication device according to claim 1, wherein the second display mode is a layout with single-choice-keys.

10. Communication device according to claim 9, wherein each set of single-choice-keys is associated with one specific multi-choice key.

11. Communication device according to claim 9, wherein the individual single- or multi-mode keys in each mode is associated with an individual set of display coordinates.

12. Method for controlling character input and image display in a communication device comprising a combined input and display device, a control unit and a proximity sensor, said method comprising the following steps;
detecting when a pointer is within a first predetermined distance from the display;
generating a first control signal upon detection that the pointer is within the first predetermined distance,
changing display modes, from a first to a second display mode as a response to the first control signal.

13. Method according to claim 12, further comprising the step of storing the display-coordinates that are closest to the pointer upon detection thereof.

14. Method according to claim 12, further comprising the steps of;
detecting when a pointer is withdrawn more then a second predetermined distance from the display device,
generating a second control signal upon the detection of withdrawal of the pointer,
changing display modes from the second to the first display mode as a response to the second control signal.

15. Method according to claim 14, wherein the second predetermined distance is greater than the first predetermined distance.

16. Method according to claim 12, further comprising the steps of;
detecting when a pointer is within a third predetermined distance from the display device,
generating a third control signal upon the detection of pointer within the third predetermined distance,
inputting a value to the communication device in response to the third control signal.

17. Method according to claim 16 wherein the third predetermined distance is smaller than the first predetermined distance.

18. Method according to claim 16, wherein the combined input and display is touch sensitive and wherein the third control signal is generated when the pointer is touching the display.

19. Method according to claim 12, wherein the first display mode shows a layout with multi-choice-keys.

20. Method according to claim 12, wherein the second display mode shows a layout with single-choice-keys.

21. Method according to claim 20, wherein each set of single-choice-keys is associated with one specific multi-choice key.

22. Method to claim 20, wherein the individual single- or multi-mode keys in each mode are associated with an individual set of display coordinates.

23. A computer program comprising code means for performing the steps of claim 12, when the program is run on the control unit.

24. A computer program product comprising program code means stored on a computer readable medium for performing the method of claim 12, when said product is run on the control unit.
